(19) United States
(12) Patent Application Publication
(10) Pub. No.: US 2008/0248379 A1
(43) Pub. Date: Oct. 9, 2008

(54) Battery unit

(75) Inventors: Tomoyasu Takeuchi, Aichi-ken (JP); Hiroshi Ueshima, Anjo-shi (JP); Ryuuichirou Shinkai, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/078,555

(22) Filed: Apr. 1, 2008

(30) Foreign Application Priority Data
Apr. 5, 2007 (JP) 2007-099780

(51) Int. Cl. H01M 10/50

(52) U.S. Cl. 429/120

(57) ABSTRACT

The battery unit includes battery cells each of which has a case containing its electrode body, and its positive and negative terminals in a state that an end portion of the positive terminal and an end portion of the negative terminal are exposed outside the case. The battery unit is provided with radiators each of which is thermally connected to at least one of these end portions of at least corresponding one of the battery cells. The positive and negative terminals of the battery cells are cooled by a flow of coolant supplied to the radiators. The battery unit is further provided with a coolant supply passage through which the coolant is supplied to the radiators, and a coolant discharge passage through which the coolant which has passed through each of the radiators is discharged without passing through any other of the radiators.

### CROSS-REFERENCE TO RELATED APPLICATION

This application is related to Japanese Patent Application No. 2007-99780 filed on Apr. 5, 2007, the contents of which are hereby incorporated by reference.

### BACKGROUND OF THE INVENTION

1. Field of the Invention

The present invention relates to a battery unit including a plurality of battery cells.

2. Description of Related Art

Recently, the lithium battery and nickel battery with high output power and high energy capacity are coming into practical use as a power supply for driving a vehicle. They are used in the form of a battery unit in which a plurality of battery cells are connected in series. Such a battery unit undergoes intense charging/discharging cycles when it is used for driving a vehicle. This may cause a temperature rise of the battery unit by heat generation due to chemical reactions in the battery cells, which degrades the performance of the battery unit.

Japanese Patent Application Laid-open No. 2002-56904 discloses a battery unit having means for suppressing the temperature rise. This battery unit includes a plurality of battery cells, and a radiator plate fixed to the terminal portions of the battery cells. The heat generated from the battery cells is dissipated to the outside through this radiator plate.

If this battery cell is provided with means for sending cooling air along the radiator plate, the cooling efficiency can be increased. However, in this case, the cooling efficiency lowers with distance from the upstream side of the air flow, because the temperature of the cooling air increases by the heat generated from the battery cells. Accordingly, it is not possible to uniformly cool the battery cells with such a means.

### SUMMARY OF THE INVENTION

The present invention provides a battery unit including a plurality of battery cells each of which includes an electrode body constituted of a positive electrode and a negative electrode, a positive terminal connected to the positive electrode, a negative terminal connected to the negative terminal, and a case containing the electrode body, and the positive and negative terminals in a state that an end portion of the positive terminal and an end portion of the negative terminal are exposed outside the case, the battery unit comprising:

a plurality of radiators each of which is thermally connected to at least one of the end portion of the positive terminal and the end portion of the negative terminal of at least corresponding one of the battery cells, the positive and negative terminals of the battery cells being cooled by a flow of coolant supplied to the radiators;

a coolant supply passage through which the coolant is supplied to the radiators; and

a coolant discharge passage through which the coolant which has passed through each of the radiators is discharged without passing through any other of the radiators.

The present invention also provides a battery unit including a plurality of battery cells each of which includes an electrode body constituted of a positive electrode and a negative electrode, a positive terminal connected to the positive electrode, a negative terminal connected to the negative terminal, and a case containing the electrode body, and the positive and negative terminals in a state that an end portion of the positive terminal and an end portion of the negative terminal are exposed outside the case, the battery unit comprising:

a plurality of radiators thermally connected to the case of each battery cell, the radiators cooling the case of each battery cell by a flow of coolant supplied to said radiators;

a coolant supply passage through which the coolant is supplied to the radiators; and

a coolant discharge passage through which the coolant which has passed through each of the radiators is discharged without passing through any other of the radiators.

According to the present invention, it is possible to provide a battery unit capable of uniformly cooling the battery cells included therein irrespective of the locations of these battery cells.

Other advantages and features of the invention will become apparent from the following description including the drawings and claims.

### BRIEF DESCRIPTION OF THE DRAWINGS

In the accompanying drawings:

FIG. 1 is a perspective view of a battery unit of a first embodiment of the present invention;

FIG. 2 is a perspective view of a battery cell included in the battery unit;

FIG. 3 is a perspective view showing a structure of the battery unit inside its cover.

FIG. 4 is a diagram for explaining how the coolant flows in the battery unit;

FIG. 5 is a diagram for explaining how the coolant flows in a comparative example of the battery unit;

FIG. 6 is a graph showing measurements of saturation temperatures of the battery cells in the battery unit of the first embodiment and the comparative example;

FIG. 7 is a diagram for explaining how the coolant flows in a battery unit of a second embodiment of the present invention;

FIG. 8 is a diagram for explaining how the coolant flows in a battery unit of a third embodiment of the present invention; and

FIG. 9 is a diagram for explaining how the coolant flows in a battery unit of a fourth embodiment of the present invention.

### PREFERRED EMBODIMENTS OF THE INVENTION

### First Embodiment

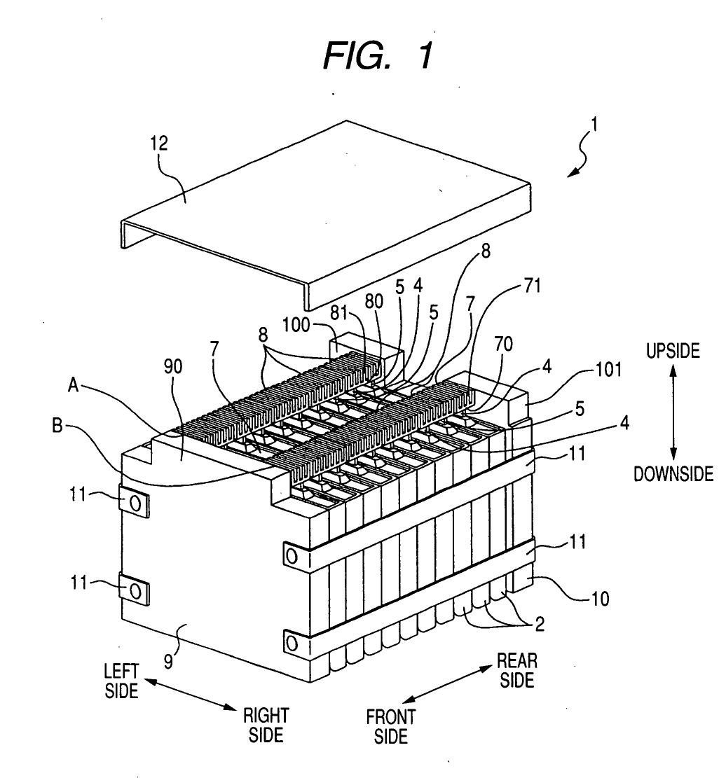

A battery unit of a first embodiment of the invention is described with reference to FIGS. 1 to 3.

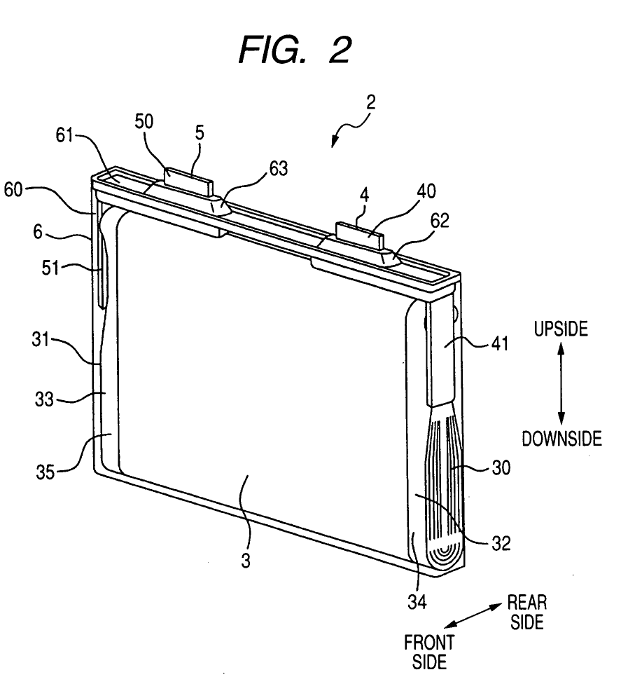

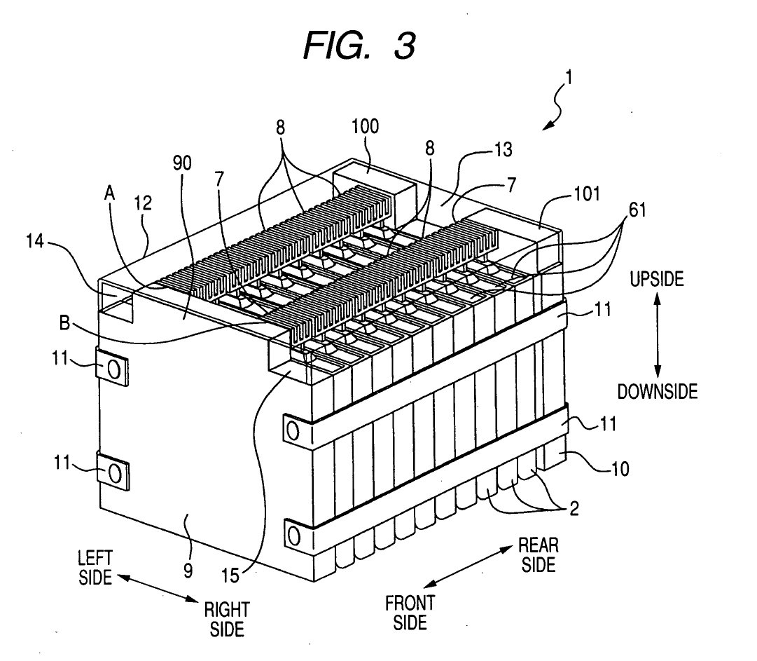

FIG. 1 is a perspective view of the battery unit of the first embodiment. FIG. 2 is a perspective view of a battery cell included in the battery unit. FIG. 3 is a perspective view showing a structure of the battery unit inside its cover. The labels “front side”, “rear side”, “left side”, “right side”, “upside”, and “downside” in these figures are for facilitating explanation of the structure of the battery unit.

As shown in FIG. 1, the battery unit 1 is constituted of a plurality of battery cells 2, a plurality of radiators 7, a plurality of radiators 8, a pair of holding members 9, 10, a plurality of connecting members 11, and a cover 12.

As show in FIG. 2, the battery cell 2 is constituted of an electrode body 3, a positive terminal (a cathode terminal) 4, a negative terminal (an anode terminal) 5, and a case (battery container) 6.

The electrode body 3 is constituted of a positive plate 30, a negative plate 31, and a separator (not shown). The positive plate 30 is made of aluminum in the form of a strip-shaped sheet. A cathode activating substance layer including lithium nickel oxide, binder, and conductive material is formed on the both sides of the positive plate 30. The positive plate 30 includes a peripheral portion 32 on which no cathode activating substance layer is formed at its one end portion in the width direction. The negative plate 31 is made of copper in the form of a strip-shaped sheet. An anode activating substance layer including graphite and a binder is formed on the both sides of the negative plate 31. The negative plate 31 includes a peripheral portion 33 on which no anode activating substance layer is formed at its one end portion in the width direction. The separator is made of polyethylene in the form of a micro-porous sheet. The electrode body 3 is formed by coiling the positive plate 30 and the negative plate 31 arranged in a single layer through the separator, and then flattening it. The peripheral portion 32 of the positive plate 30 forms a projecting end portion 34 which projects towards one end portion of the electrode body 3 in the axial (longitudinal) direction. The peripheral portion 33 of the negative plate 31 forms a projecting end portion 35 which projects towards the other end portion of the electrode body 3 in the axial direction.

The positive terminal 4, which is for connecting the positive plate 30 to the outside, is a plate-like member made of aluminum. The positive terminal 4 is constituted of a terminal portion 40, and a connecting portion 41. The terminal portion 40 having a rectangular plate shape is for connecting the positive terminal 4 to the outside. The connecting portion 41 connected to the terminal portion 40 and having a rectangular plate shape is for connecting the positive terminal 4 to the positive plate 30. The connecting portion 41 is connected to the projecting end portion 34 of the positive plate 30.

The negative terminal 5 is made of copper in the form of a plate-like member. The negative terminal 5 is constituted of a terminal portion 50, and a connecting portion 51. The terminal portion 50 having a rectangular plate shape is for connecting the negative terminal 5 to the outside. The connecting portion 51 connected to the terminal portion 50 and having a rectangular plate shape is for connecting the negative terminal 5 to the negative plate 31. The connecting portion 51 is connected to the projecting end portion 35 of the negative plate 31.

The case 6 containing the electrode body 3 connected with the positive terminal 4 and the negative terminal 5 is a hollow rectangular parallelepiped member made of aluminum, which supports the positive terminal 4 and the negative terminal 5. The case 6 is constituted of a main portion 60 having a shape of a bottomed rectangular tube, and a lid portion 61 having a shape of a rectangular plate. The main portion 60 houses the electrode body 3 connected with the positive terminal 4 and the negative terminal 5 through an insulation member (not shown). The opening portion of the main portion 60 is sealed by the lid portion 61. The positive terminal 4 and the negative terminal 5 are fixed to the lid portion 61 through insulation seal members 62, 63 with the terminal portions 40, 50 protruding outward.

As shown in FIG. 1, the battery cells 2 are stacked in the front-rear direction in such a state that the major surfaces of the adjacent two battery cells 2 contact with each other, and the positive terminal 4 and negative terminal 5 alternate in the front-rear direction.

The radiator 7, which is made of metal such as aluminum, is thermally connected to the positive terminal 4 or the negative terminal 5, so that these terminals are cooled by the flow of coolant. The radiator 7 is constituted of a main portion 70 having a shape of a rectangular plate, and a plurality of rectangular plate-like fin portions 71 projecting from the surface of the main portion 70 and extending from one end side to the other end of the main portion 70. The radiator 7 is thermally connected, by welding, for example, to the positive terminal 4 of the rearmost battery cell 2, or the negative terminal 5 of the frontmost battery cell 2.

The radiator 8, which is made of metal such as aluminum, is thermally connected to the positive terminal 4 and the negative terminal 5, so that these terminals are cooled by the flow of coolant. The radiator 8 also serves as a member electrically connected to the positive terminal 4 and the negative terminal 5 in order that the battery cells 2 are connected in series. The radiator 8 is constituted of a main portion 80 having a shape of a square plate, and a plurality of rectangular plate-like fin portions 81 projecting from the surface of the main portion 80 and extending from one end side to the other end of the main portion 80. Each radiator 8 is thermally connected to, by welding, for example, and electrically connected to the positive terminal 4 of the frontwardly adjacent battery cell 2 at its negative terminal 5, and to the negative terminal 5 of the rearwardly adjacent battery cell 2 at its positive terminal 4 with its fin portions 81 extending in the left-right direction.

Accordingly, the radiators 7, 8 are arranged in two rows extending in the front-rear direction to form radiator groups A, and B.

The holding members 9, 10 are rectangular plate-like members for holding the stacked battery cells 2 therebetween. Each of the holding members 9, 10 has roughly the same width in the left-right direction as that of the major surface of the main portion 60. The holding member 9 is provided with a rectangular plate-like wall portion 90 at its upper end surface. The holding member 10 is provided with rectangular plate-like wall portions 100, 101 at the left and right sides of its upper end portion, respectively. The holding member 9 is assembled so as to be in contact with the main portion 60 of the frontmost battery cell 2. The holding member 10 is assembled so as to be in contact with the main portion 60 of the rearmost battery cell 2.

The connecting members 11 for connecting the holding members 9, 10 are rectangular plate-like members shaped in C to hold the stacked battery cells 2. The end portions of each connecting member 11 are respectively fixed to the end surfaces of holding members 9 and 10.

The cover 12, which is a rectangular plate-like member, is for protecting the stacked battery cells 2. The cover 12 is C-shaped so that its also constitutes a later-described coolant supply passage 13 and a coolant discharge passages 14, 15. As shown in FIG. 3, the cover 12 covers the upper side of the radiator groups A, B, and the wall portions 90, 100, 101.

The coolant supply passage 13 is formed by the lid portions 61 of the battery cells 2, the wall portion 90 of the holding member 9, and the cover 12. The coolant supply passage 13 lies between the radiator groups A, B, and extends in the front-rear direction. The coolant supply passage 13 opens at its rear end, and communicates to the right sides of the radiators 8 constituting the radiator group A, and to the left sides of the radiators 7, 8 constituting the radiator group B at its front side.

The coolant discharge passages 14, 15 are formed by the lid portions 61 of the battery cells 2, the wall portions 100, 101 of the holding member 10, and the cover 12. The coolant discharge passage 14 lies at the left side of the radiator group A, and extends in the front-rear direction. The coolant discharge passage 14 communicates to the left sides of the radiators 8 constituting the radiator group A at its rear side, and opens at its front end. The coolant discharge passage 15 lies at the right side of the radiator group B, and extends in the front-rear direction. The coolant discharge passage 15 communicates to the right sides of the radiators 7, 8 constituting the radiator group B at its rear side, and opens at its front end.

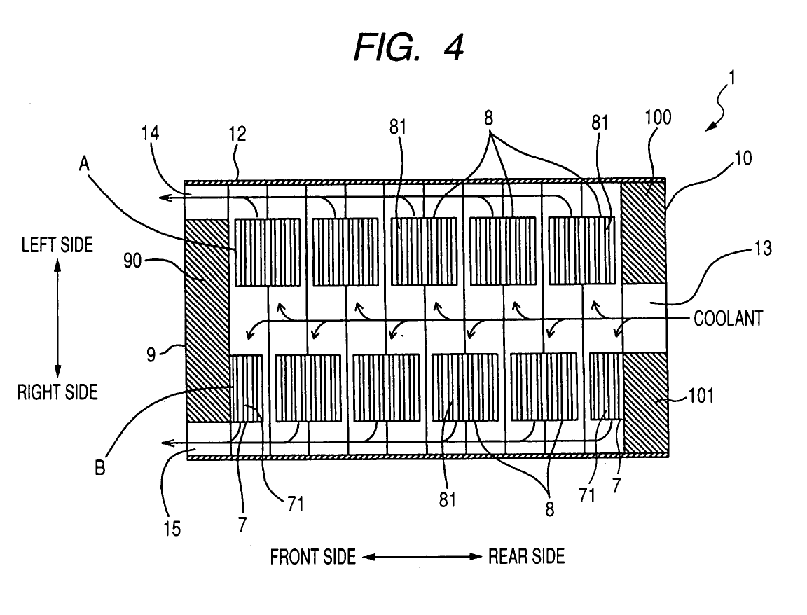

Next, the cooling operation of the battery unit 1 having the above described structure is explained with reference to FIG. 4 which shows how coolant flows.

As shown in FIG. 4, air as coolant is supplied from the opening formed at the rear end of the coolant supply passage 13 by a fan. The coolant flows frontward inside the coolant supply passage 13, to be supplied to the radiator groups A, B. The coolant supplied to the radiators 8 constituting the radiator group A flows from right to left along the fin portions 81, and cools the terminals. The coolant that has passed any radiator 8 flows frontward inside the coolant discharge passage 14 without flowing into any other radiator, and is discharged from the opening formed in the front end of the coolant discharge passage 14. On the other hand, the coolant supplied to the radiators 7, 8 constituting the radiator group B flows from left to right along the fin portions 71, 81, and cools the terminals. The coolant that has passed any radiator 7 or 8 flows frontward inside the coolant discharge passage 15 without flowing into any other radiator, and is discharged from the opening formed in the front end of the coolant discharge passage 15.

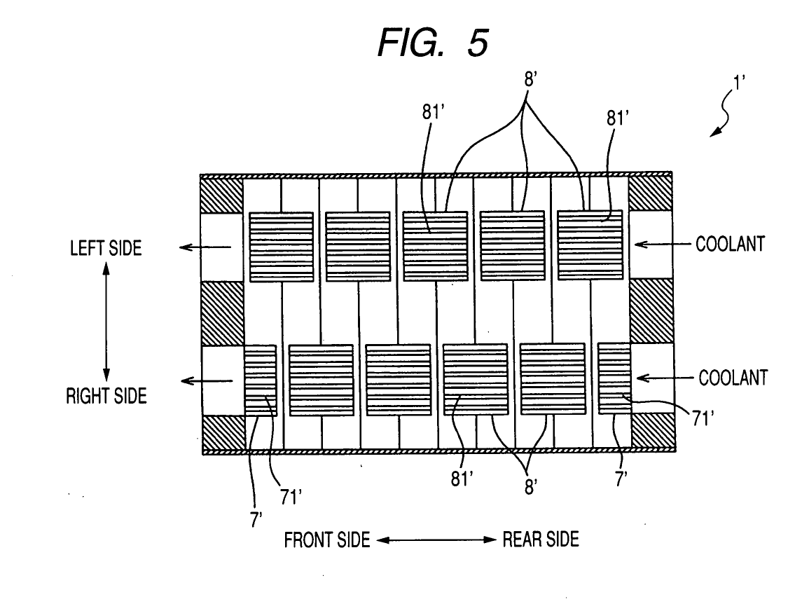

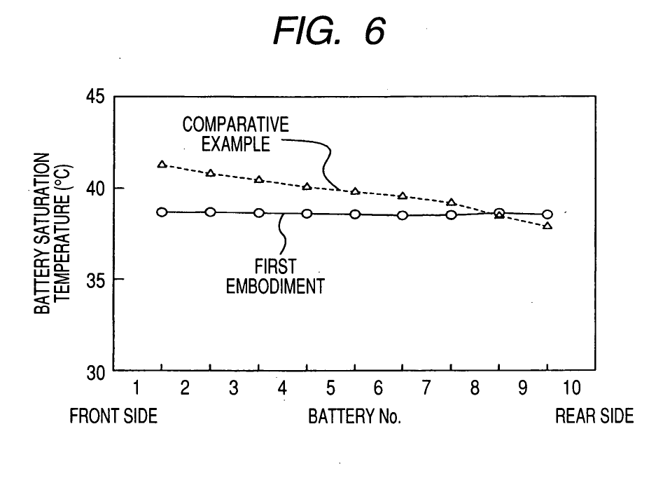

Next, the cooling effect of the battery unit 1 of this embodiment is explained with reference to FIGS. 5, 6. FIG. 5 is a diagram explaining how the coolant flows in a comparative example of the battery unit 1′ in which the fin portions 81′ of the radiators 8′ are arranged in a row extending in the front-rear direction, and the fin portions 7′, 8′ of the radiators 7′, 8′ are arranged in another row extending in the front-rear direction. FIG. 6 is a graph showing measurements of saturation temperatures of the battery cells 2.

The marks “O” in this graph show saturated temperatures of the major surfaces of the main portions 60 of the battery cells 2 measured under the condition that the battery unit 1 including 10 pieces of the battery cells 2 repeats charge-discharge cycles at 10-second intervals at a current of 30 A, and the coolant is supplied into the coolant supply passage 13 at a temperature of 30 degrees C. and at a volume of 8 m³/hr. The marks “Δ” in this graph shows the saturated temperatures in the comparative example measured in the same condition as above.

As seen form FIG. 6, in the comparative example, the saturation temperatures vary from 38 degrees C. to 41 degrees C. depending on the locations of the battery cells, while, in the first embodiment of the invention, the saturation temperatures are constant at around 39 degrees C.

In the first embodiment, the electrode body 3 is connected to the positive terminal 3 and the negative terminal 4. The heat generated from the electrode body 3 is transmitted to the positive terminal 3 and the negative terminal 4. The positive terminal 3 and the negative terminal 4 are thermally connected with the radiators 7 or 8. The radiators 7, 8 are arranged in two rows to constitute the radiator groups A and B.

Between the radiator groups A and B, the coolant supply passage 13 is formed extending in the front-rear direction. The coolant supply passage 13 opens at its rear end, and communicates to the right side of the radiator group A, and to the left side of the radiator group B at it s front end. Accordingly, the radiators 7, 8 constituting the radiator groups A, B can be reliably supplied with the coolant through the coolant supply passage 13.

At the left of the radiator group A, the coolant discharge passage 14 is formed extending in the front-rear direction. The coolant discharge passage 14 communicates to the left side of the radiator group A at its rear side, and opens at its front end. At the right of the radiator group B, the coolant discharge passage 15 is formed extending in the front-rear direction. The coolant discharge passage 15 communicates to the right side of the radiator group B at its rear side, and opens at its front end. Accordingly, the coolant that has passed any radiator 7 or 8 constituting the radiator groups A, B can be discharged without passing thorough any other radiator. Unlike conventional battery units, it does not occur that the coolant whose temperature has risen due to the heat generated from the upstream radiators flows into the downstream radiators. Accordingly, all of the radiator 7 or 8 constituting the radiator groups A, B can be supplied with the coolant with less temperature variation. That is, all the battery cells 2 constituting the battery unit 1 can be cooled uniformly irrespective of their locations.

In the first embodiment, the radiator 7 (8) is constituted of the plate-like main portion 70 (80), and the fin portions 71 (81) projecting from the surface of the main portion 70 (80). The fin portions 71 (81) extend from the side of the coolant supply passage 13 to which the coolant is supplied to the side of the coolant discharge passage 14 from which the coolant is discharged. This ensures a sufficiently large coolant-contact area, and a sufficiently small coolant flow resistance, to thereby increase the cooling performance of the radiators 7, 8.

In the first embodiment, the radiator 8 is made of metal, and electrically connected to the positive terminal 4 or the negative terminal 5 of the frontwardly adjacent radiator, and to the negative terminal 5 or the positive terminal 4 of the rearwardly adjacent radiator, in order for the battery cells 2 constituting the battery unit 1 to be connected in series. This makes it possible to reduce the component count of the battery unit 1, because wiring members for connecting the battery cells 2 are not needed.

Although the coolant is supplied from the opening of the coolant supply passage 13 by the fan in the first embodiment, the coolant may be supplied by a booster pump. The coolant may be discharged from the coolant discharge passages 14, 15 by use of a discharge fan or a vacuum pump. By making the pressure at the side of the opening of the coolant supply passage 13 higher than that at the side of the coolant discharge passages, it is ensured that the coolant flows from the coolant supply passage, passes through the radiators, and flows into the coolant discharge passages.

In the first embodiment, the coolant is caused to flow from the rear side to the front side of the battery unit, however, it is possible to cause the coolant to flow from the front side to the rear side, because the coolant discharge passages 14, 15 can be used as coolant supply passages, and the coolant supply passage 13 can be used as a coolant discharge passage.

In the first embodiment, although the battery cells 2 are placed such that the positive terminal 4 and the negative terminal 5 alternate in the front-rear direction, they may be placed such that the positive terminals 4 are arranged in a first row and the negative terminals 5 are arranged in a second row, in order for the battery cells 2 to be connected in parallel. Also in this case, since each of the row of positive terminals and the row of negative terminals can be electrically connected through the radiators without using wiring members, the component count can be reduced.

Although the radiators 7, 8 are thermally connected to the positive terminals 4 or the negative terminals 5, they may be thermally connected to the case 6. Also in this case, the same advantages can be obtained.

### Second Embodiment

Next, a second embodiment of the present invention is described. The second embodiment differs from the first embodiment in the shape of the fin portions.

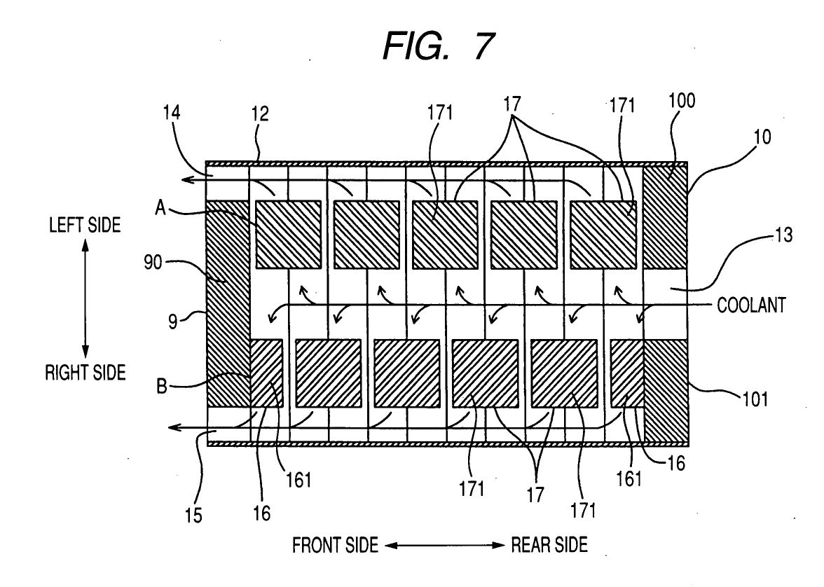

FIG. 7 is a diagram showing how the coolant flows in the battery unit of the second embodiment. The following explanation on the second embodiment focuses on the difference with the first embodiment.

As shown in FIG. 7, the fin portions 171 of the radiators 17 constituting the radiator group A extend from right rear to left front. The fin portions 161, 171 of the radiators 16, 17 constituting the radiator group B extend from left rear to right front. This makes it possible to make the coolant flow resistance at the radiators smaller than that in the first embodiment, to thereby further increase the cooling performance of the radiators.

### Third Embodiment

Next, a third embodiment of the present invention is described. The third embodiment differs from the first embodiment in the shape of the fin portions.

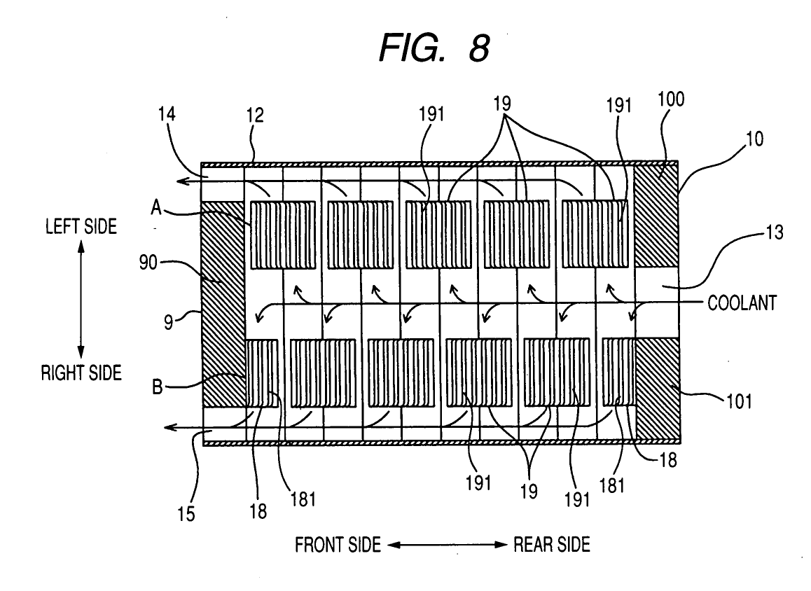

FIG. 8 is a diagram showing how the coolant flows in the battery unit of the third embodiment. The following explanation on the third embodiment focuses on the difference with the first embodiment.

As shown in FIG. 8, the fin portions 191 of the radiators 19 constituting the radiator group A is curved towards the rear at its right end portion, and curved towards the front at its left end portion. The fin portions 181, 191 of the radiators 18, 19 constituting the radiator group B is curved towards the rear at its left end portion, and curved towards the front at its right end portion. This makes it possible to make the coolant flow resistance at the radiators smaller than that in the first embodiment, to thereby further increase the cooing performance of the radiators.

### Fourth Embodiment

Next, a fourth embodiment of the present invention is described. In the fourth embodiment, the coolant discharge direction is changed from that in the first embodiment, and guide members are provided within the coolant supply passage.

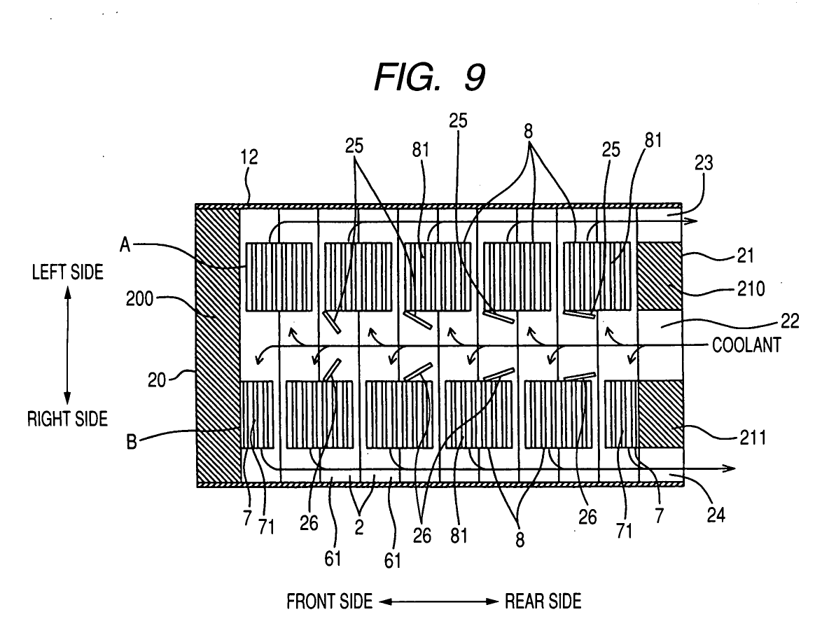

FIG. 9 is a diagram showing how the coolant flows in the battery unit of the fourth embodiment. The following explanation on the fourth embodiment focuses the difference between the fourth embodiment and the first embodiment.

As shown in FIG. 9, a wall portion 200 is provided on the upper end portion of the holding member 20. On the other hand, wall portions 210, 211 are provided on the upper end portion of the holding member 21. The lid portions 61 of the battery cells 2, the wall portion 200, and the cover 12 constitute the coolant supply passage 22 which lies between the radiator groups A, B arranged in two rows and extends in the front-rear direction. The coolant supply passage 22 opens at its rear end, communicates to the right side of the radiators 8 constituting the radiator group A and to the left sides of the radiators 7, 8 constituting the radiator group B at its front side. Within the coolant supply passage 22, plate-like guide members 25, 26 for guiding the coolant to the radiators 7, 8 are provided so as to project upward. The guide members 25 for the side of the radiator group A are tilted in the direction from right rear to left front. The guide members 26 for the side of the radiator group B are tilted in the direction from left rear to right front. The guide members 25, 26 are so arranged that their tilt angles with respect to the front-rear direction increases with increasing distance form the rear end of the coolant supply passage 22.

The lid portions 61 of the battery cells 2, the wall portion 200, and the cover 12 also constitute the coolant discharge passages 23, 24. The coolant discharge passages 23 lies at the left of the radiator group A arranged in a row extending in the front-rear direction. The coolant discharge passages 23 communicates to the left sides of the radiators 8 constituting the radiator group A at its front side, and opens at its rear end. The coolant discharge passages 24 lies at the right of the radiator group B arranged in a row extending in the front-rear direction. The coolant discharge passage 24 communicates to the right sides of the radiators 7, 8 constituting the radiator group B at its front side, and opens at its rear end.

Next, the cooling operation of the battery unit of the fourth embodiment is explained. As shown in FIG. 9, air is supplied as the coolant from the opening formed at the rear end of the coolant supply passage 22 by a fan. The coolant flows frontward inside the coolant supply passage 22, and guided by the guide members 25, 26 to be supplied to the radiator groups A, B. The coolant supplied to the radiators 8 constituting the radiator groups A flows from right to left along the fin portions 81 to cool the terminals. Thereafter, the coolant that has passed through the radiators 8 flows rearward inside the coolant discharge passage 23, and is discharged to the outside from the opening formed in the rear end of the coolant discharge passage 23. The coolant supplied to the radiators 7, 8 constituting the radiator groups B flows from left to right along the fin portions 71, 81 to cool the terminals. Thereafter, the coolant that has passed through the radiators 7, 8 flows rearward inside the coolant discharge passage 24, and is discharged to the outside from the opening formed in the rear end of the coolant discharge passage 24.

In the fourth embodiment, the coolant can be efficiently supplied to the radiators 7, 8 by the guide members 25, 26. Accordingly, according to the fourth embodiment, the cooling performance of the radiators can be still further increased.

The above explained preferred embodiments are exemplary of the invention of the present application which is described solely by the claims appended below. It should be understood that modifications of the preferred embodiments may be made as would occur to one of skill in the art.

What is claimed is:

1. A battery unit including a plurality of battery cells each of which includes an electrode body constituted of a positive electrode and a negative electrode, a positive terminal connected to said positive electrode, a negative terminal connected to said negative terminal, and a case containing said electrode body, and said positive and negative terminals in a state that an end portion of said positive terminal and an end portion of said negative terminal are exposed outside said case, said battery unit comprising:
a plurality of radiators each of which is thermally connected to at least one of said end portion of said positive terminal and said end portion of said negative terminal of at least corresponding one of said battery cells, said positive and negative terminals of said battery cells being cooled by a flow of coolant supplied to said radiators;
a coolant supply passage through which said coolant is supplied to said radiators; and
a coolant discharge passage through which said coolant which has passed through each of said radiators is discharged without passing through any other of said radiators.

2. The battery unit according to claim 1, wherein said battery cells are placed such that said radiators are arranged in a row, said coolant supply passage lies at one side of said row of said radiators, opens at one end thereof, and communicates to said one side of said row of said radiators at a side of the other end thereof, and said coolant discharge passage lies at the other side of said row of said radiators, communicates to said the other side of said row of said radiators at a side of one end thereof, and opens at the other end thereof.

3. The battery unit according to claim 1, wherein a pressure at a side where said coolant supply passage opens is set higher than a pressure at a side where said coolant discharge passage opens.

4. The battery unit according to claim 1, wherein each of said radiators includes a plate-like main portion, and a plurality of fin portions projecting from a surface of said main portion.

5. The battery unit according to claim 4, wherein said fin portions extend from a supply side of said coolant to a discharge side of said coolant.

6. The battery unit according to claim 1, wherein each of said radiators is made of metal, and adjacent two of said radiators are integrally formed with each other.

7. A battery unit including a plurality of battery cells each of which includes an electrode body constituted of a positive electrode and a negative electrode, a positive terminal connected to said positive electrode, a negative terminal connected to said negative terminal, and a case containing said electrode body, and said positive and negative terminals in a state that an end portion of said positive terminal and an end portion of said negative terminal are exposed outside said case, said battery unit comprising:
a plurality of radiators thermally connected to said case of each of said battery cells, said radiators cooling said case of each of said battery cells by a flow of coolant supplied to said radiators;
a coolant supply passage through which said coolant is supplied to said radiators; and
a coolant discharge passage through which said coolant which has passed through each of said radiators is discharged without passing through any other of said radiators.

8. The battery unit according to claim 7, wherein said battery cells are placed such that said radiators are arranged in a row, said coolant supply passage lies at one side of said row of said radiators, opens at one end thereof, and communicates to said one side of said row of said radiators at a side of the other end thereof, and said coolant discharge passage lies at the other side of said row of said radiators, communicates to said the other side of said row of said radiators at a side of one end thereof, and opens at the other end thereof.

9. The battery unit according to claim 7, wherein a pressure at a side where said coolant supply passage opens is set higher than a pressure at a side where said coolant discharge passage opens.

10. The battery unit according to claim 7, wherein each of said radiators includes a plate-like main portion, and a plurality of fin portions projecting from a surface of said main portion.

11. The battery unit according to claim 10, wherein said fin portions extend from a supply side of said coolant to a discharge side of said coolant.
